(19) United States
(12) Patent Application Publication
(10) Pub. No.: US 2005/0128348 A1
(43) Pub. Date: Jun. 16, 2005

(54) Display apparatus and method for enabling artifact-free rapid image format changes

(75) Inventor: William A. Orfitelli, Pittsford, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/736,335

(22) Filed: Dec. 15, 2003

(51) Int. Cl. H04N 7/01; H04N 11/20; G06F 13/00; H04N 7/04; H04N 5/445

(52) U.S. Cl. 348/441; 348/470

(57) ABSTRACT

A display device interface system for enabling rapid video format changes, and a method for transitioning between video formats that reduces visual noise caused by the transition between video formats.

### FIELD OF THE INVENTION

The invention relates generally to the field of Digital Displays, and in particular to Digital Display Interfaces. More specifically, the invention relates to a device that enables rapid format transitions.

### BACKGROUND OF THE INVENTION

Digital displays have evolved over the years to accept and display a wide variety of image sizes, color depths, formats, and refresh rates. Computer display cards have had to follow suit to support these standards. The first video cards used in the earliest machines conformed to the MDA (Monochrome Display Adapter) standard, established by IBM (International Business Machine) as part of the original PC (Personal Computer). MDA is a monochrome-only, text-only standard, allowing text display at 80×25 characters. Each character is made up of a matrix that is 9 dots wide by 14 dots high, yielding an effective resolution of 720×350 at a refresh rate of 50 Hz. As technology advanced, IBM PCs moved through several improved formats including, CGA (Color Graphics Adapter), EGA (Enhanced Graphics Adapter) and VGA (Video Graphics Adapter). The proliferation of display standards exploded after VGA, and as of this writing, there are nearly a hundred various legacy and new formats, with newer formats on the horizon. Typically, a display device such as a computer display or digital projector, will announce to a display adapter card using the VESA (Video Electronic Standards Association) standard DDC (Display Data Channel) interface what subset of all of the formats it is capable of displaying. The computer adapter card is then allowed to send any of the announced formats to the display device. However, there is no information sent to the display device describing the format sent by the computer adapter card. The display device must analyze the signal itself and determine what format it was sent. The display device can take several seconds to perform this analysis. The analysis conducted by the display device can include, but is not limited to: determining the horizontal and vertical refresh frequency; determining the number of valid image pixels per line and number of valid image lines per frame; and determining if the image data is interleaved or progressively scanned. Valuable time is needed to perform this analysis and can result in the display of “transition noise,” which are image artifacts caused by the transition. These image artifacts can also cause the display device to have erroneous conclusions about the format. This is one reason why, when a personal computer user asks the operating system to change the format of the display screen, the operating system has the user examine the result of the change and if the user does not respond affirmatively within a few seconds, the operating system will automatically change the format back to the previous display screen format. In some cases, a format change results in a blank or illegible screen, because the display device analyzed the format incorrectly.

In U.S. Pat. No. 5,448,697, “Method and Apparatus for Simplified Control of a Video Monitor”, which issued on 5 Sep. 1995 in the names of Terry J. Parks and Joseph W. Bell, Jr., the inventors discuss a method for retrieving information on allowable formats from a display. This technique does not relieve the display from the task of analyzing the format ultimately chosen by the computer operator to determine which one is to be used.

In U.S. Pat. No. 6,247,090, “Display Apparatus Enabled to Control Communicatability with an External Computer Using Identification Information”, which issued on 12 Jun. 2001 in the names of Ikuya Arai and Kouji Kitou, which relies on a pre constructed database of formats associated with unique display identification numbers. The display device reports the unique number to the computer, which then looks up the allowed formats. This process also does not address the resulting analysis that must be performed by the display when multiple allowable formats are available.

UK Patent Application GB 2314493 A, “Monitor communicates with computer via serial peripheral interface”, filed on 18 Jun. 1997 in the name of Mun Seob Kim, describes a method of controlling monitor parameters from a computer, primarily to allow for a method of providing a user interface for changing monitor parameters like brightness using the computers keyboard rather than having buttons on the display itself. This control interface again does not address the issue of format analysis by the display.

### PROBLEM TO BE SOLVED BY THE INVENTION

In most computer applications the time consuming and error prone analysis of format changes by a display device is not an issue, because it is performed infrequently. In some display venues, the format detection can become uncomfortable for users, such as in business presentations where a digital projector video connection is swapped between several laptop computers. Even more of a problem occurs in the presentation of entertainment media to audiences. During such media transitions between formats, the display of format transition noise can be unacceptable to content creators, audiences, and exhibitors. What is needed is a way to rapidly transition between formats without any perceptible visual noise.

### SUMMARY OF THE INVENTION

A display device interface system for enabling rapid video format changes, and a method for transitioning between video formats that reduces visual noise caused by the transition between video formats.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a block diagram of an image Processing Unit connected to a Display Device with both an Image Interface and a Rapid Format Change Display Control Interface.

FIG. 2 is a flowchart of the image format change protocol.

To facilitate understanding, identical reference numerals have been used, where possible, to designate identical elements that are common to the figures.

### DETAILED DESCRIPTION OF THE INVENTION

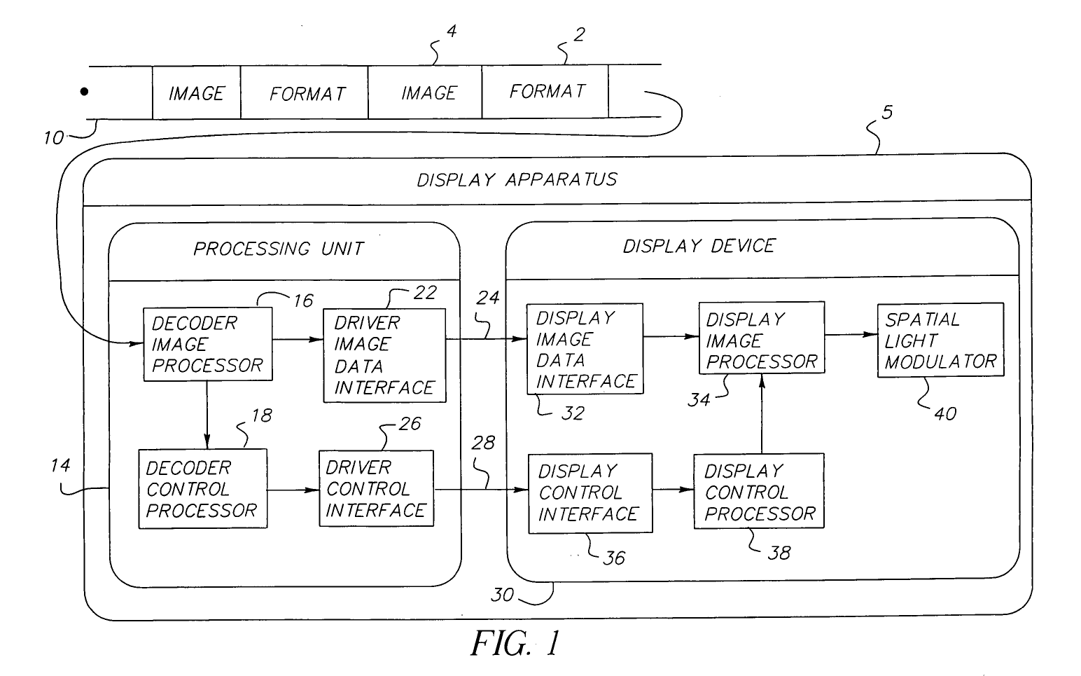

Referring to FIG. 1, a display apparatus (5) capable of rapid video format transitioning includes communications interfaces (24) and (28) that transmit the specification of image format to a display device (30). An image format as discussed herein, refers to frame rate, pixel width, number of lines in an image, and inter-line and inter-fame timing. Image format data, generically refers to a description of an image's composition. The image format data encodes the format parameters for a corresponding image. In one embodiment, as shown in FIG. 1, streaming image content (10) includes image data (2) and format data (4) which may be either live event video, stored motion advertisement, stored advertisement still images, or a motion picture feature. The format data (4) may be present for every image data frame, or may be present only when there is a format change. The streaming image content (10) is presented to a processing unit (14). The processing unit is responsible for isolating the content elements of interest from a stream that may contain more than is of interest, for instance, there may be multiple subtitle elements for various languages and only one is desired. The image processing unit is also responsible for any decompression and decryption, and for any image manipulations such as color space, scaling, or filtering. The streaming image content (10) also includes data that describes the format of the image data (2). A decoder image processor (16) strips image format data (4) from the image data (2). The decoder image processor (16) prepares the image data (2) for the display device (30). As part of the preparation, the image data (2) is mapped to an interface format for subsequent use by the display device (30). The prepared image data (2) is presented to the Driver Image Data Interface (22) which translates the image data (2) from an internal representation to one that is recognized by the Display Device (30). Additionally, the image data (2) is sent across a Display Image Data Physical Interface (24) that can be several feet long. A corresponding Display Image Data Interface (32) within the Display Device (30) accepts the image data (2) and converts its format to one useable within the Display Device (30). Image Data (2) is further processed by a Display Image Processor (34) to alter its format to meet the requirements of a Spatial Light Modulator (40). One example of altering the format of image data (2), is the inclusion of blank pixels and lines to meet timing requirements of the spatial light modulator 40. In order to determine the correct conversion of format, the Display Image Processor (34) gets information from the Display Control Processor (38) such as the frame rate, pixel width and number of lines in the images. The Display Image Processor (34) may need to increase the frame rate, may need to add padding pixels before or after the image pixels, or may need to add padding lines before and after image data to meet the requirements of the Spatial Light Modulator (40). Information about the format of the image data is conveyed to the Display Control Processor (38) via the Rapid Format Change Display Control Interface (36), the Rapid Format Change Display Control Physical Interface (28) which in this embodiment is based on the RS232 communications standard, the Rapid Format Change Driver Control Interface (26) which translates program instructions for a particular operating system such as UNIX to signals compatible with the physical interface, the Decoder Control Processor (18) which examines streaming image content format data and translates format changes to instructions that are issued to the Driver Control Interface, and ultimately from the Decoder Image Processor (16) that stripped the format data (4) out of the Streaming Image Content (10).

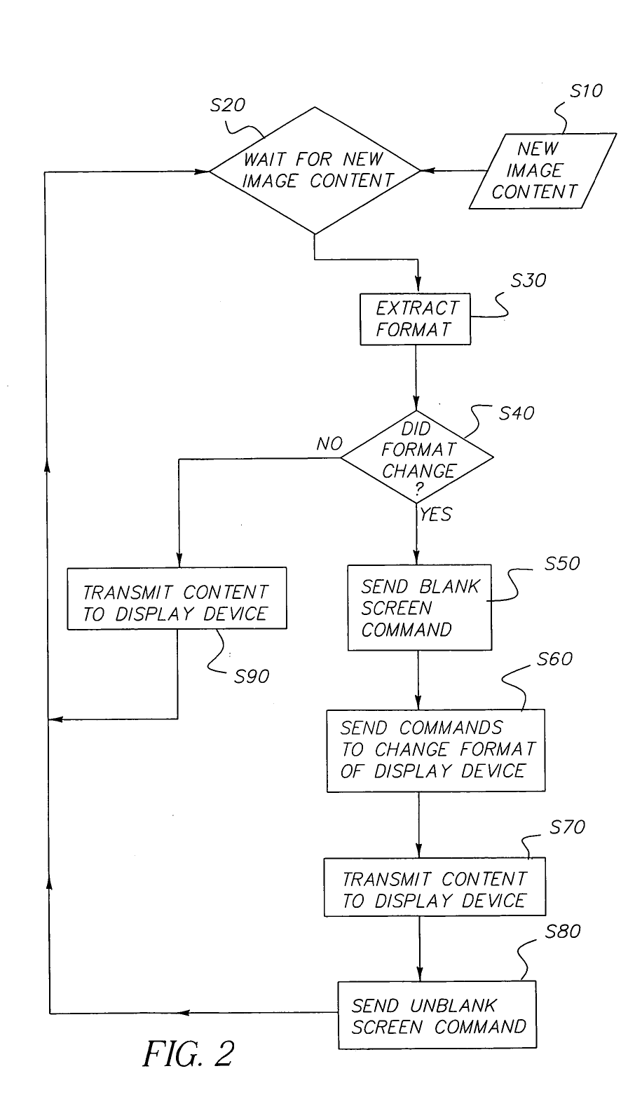

An exemplary process of effecting a rapid format change without visible display artifacts is described in FIG. 2 utilizing the previously described elements shown in FIG. 1. In this process, new image content arrives in operation (S10). The new image content exits a wait loop in operation (S20), and any format data contained therein is extracted in operation (S30). Further examination of the new image content occurs in operation (S40) to see if the format is different from previous Image Content. If the format did not change, the New Content is sent to the Display Device 30 via operation (S90) and the process returns to operation (S20), waiting for new image content.

If the format did change, a blank screen command is transmitted in operation (S50) via Rapid Format Control Interface 26. The appropriate commands to configure the Display Device 30 for the changed format are then transmitted via the Rapid Format Control Interface 26 in operation (S60). Subsequently, the new image content is then transmitted to the Display Device 30 in operation (S70). As part of the transmission of format change, there may be a delay as the Display Device reconfigures for the new format, and a handshake may be required to determine that the Display Device 30 is ready. Any display artifacts that could be generated as a result of changing formats are hidden due to the blanked mode of the Display Device 30. Under operation (S80) an unblank command is issued to the Display Device 30 and the entire process repeats, looking for new image content in operation (S20).

Unwanted artifacts that are avoided by this method can include single frames that are inserted that are either totally or partially non-black, one or more horizontal lines or pixels that are not part of the intended image content, or presentations of a previous frame that are otherwise distorted or scrambled.

The invention has been described with reference to a preferred embodiment. However, it will be appreciated that variations and modifications can be effected by a person of ordinary skill in the art without departing from the scope of the invention.

### Parts List

2 Image Data
4 Format Data
5 Display Apparatus
10 Streaming Image Content
14 Processing Unit
16 Decoder Image Processor
18 Decoder Control Processor
20 Display Driver
22 Display Driver Data Interface
24 Display Image Data Physical Interface
26 Rapid Format Change Driver Control Interface
28 Rapid Format Change Display Control Physical Interface
30 Display Device
32 Display Image Data Interface
34 Display Image Processor
36 Rapid Format Change Display Control Interface
38 Display Control Processor
40 Spatial Light Modulator
S10 Operation
S20 Operation
S30 Operation
S40 Operation
S50 Operation
S60 Operation
S70 Operation
S80 Operation
S90 Operation

1. A display apparatus for enabling artifact-free rapid image format changes to a display device, comprising:
a) a processing unit arranged to automatically receive and process a packet of streaming image content, including,
i) a decoder image processor that receives the packet of streaming image content via a digital process unit content interface,
ii) a decoder control processor that receives the packet of streaming image content from the decoder image processor, and
iii) a display driver that receives the packet of streaming image content from the decoder image processor and the decoder control processor as formatted image data, whereupon the display driver translates the formatted image data for transmission;
b) a display device, including
i) a display image data interface that receives the formatted image data from the display driver via a display image data physical interface,
ii) a display control interface that receives the format data from the display driver via a rapid format change display control physical interface,
iii) a display image processor for converting the image data to artifact-free image data before subsequent transmission;
iv) a spatial light modulator for receiving the artifact-free image data from the display image processor, and
v) a display control processor for controlling and transmitting format data to the display image processor.

2. The display apparatus claimed in claim 1, wherein the spatial light modulator is blanked during known transition delays of an image format change to produce the artifact-free image data.

3. The rapid video interface system claimed in claim 1, wherein the display driver includes:
a) a driver image data interface that receives the formatted image data from the decoder image processor; and
b) a driver control interface that receives information on the format data from the decoder control processor.

4. The display device interface system of claim 1, wherein transmission of the format data is over a display control physical interface selected from the group consisting of: RS232, I2C, Ethernet, and Firewire.

5. The display device interface system of claim 3, wherein the driver image data interface is selected from the group consisting of: VESA, DVI or SMPTE (Society of Motion Picture and Television Engineers) standard video or display interface.

6. A method for automatically transitioning between image formats that reduces visual noise caused by the transition between image formats, comprising the steps of:
a) waiting for arrival of new image content;
b) extracting format information from the new image content;
c) analyzing format information for recognizable changes;
d) sending a blank screen command to a display device where the format information did change;
e) sending a change format command to the display device where the format information did change;
f) transmitting the new image content to the display device where the format information did change;
g) sending an unblank screen command to the display device where the format information did change;
h) returning to step (a);
i) alternatively, transmitting the new image content to the display device where the format information did not change; and
j) returning to step (a).

7. A method for automatic rapid transitioning between image formats that reduces visual noise caused by the transition between image formats, comprising the steps of:
a) waiting for arrival of new image content;
b) extracting format information from the new image content;
c) analyzing format information for recognizable changes;
d) sending a change format command to the display device where the format information did change;
f) transmitting the new image content to the display device where the format information did change;
g) returning to step (a);
h) alternatively, transmitting the new image content to the display device where the format information did not change; and
i) returning to step (a).
